(19) United States
(12) Patent Application Publication
(10) Pub. No.: US 2015/0206000 A1
(43) Pub. Date: Jul. 23, 2015

(54) BACKGROUND ANALYSIS OF MENTAL STATE EXPRESSIONS

(71) Applicant: AFFECTIVA, INC., Waltham, MA (US)

(72) Inventors: Rana el Kaliouby, Milton, MA (US); Timothy Peacock, Concord, MA (US); Gregory Poulin, Acton, MA (US)

(21) Appl. No.: 14/672,328

(22) Filed: Mar. 30, 2015

Related U.S. Application Data
(63) Continuation-in-part of application No. 13/153,745, filed on Jun. 6, 2011.
Application No. 13/153,745 is a continuation-in-part of application No. 14/460,915, filed on Aug. 15, 2014.
Application No. 14/460,915 is a continuation-in-part of application No. 13/153,745, filed on Jun. 6, 2011.
(60) Provisional application No. 61/972,314, filed on Mar. 30, 2014.
(60) Provisional application No. 62/023,800, filed on Jul. 11, 2014.
(60) Provisional application No. 62/047,508, filed on Sep. 8, 2014.
(60) Provisional application No. 62/082,579, filed on Nov. 20, 2014.
(60) Provisional application No. 62/128,974, filed on Mar. 5, 2015.
(60) Provisional application No. 61/352,166, filed on Jun. 7, 2010.
(60) Provisional application No. 61/388,002, filed on Sep. 30, 2010.
(60) Provisional application No. 61/414,451, filed on Nov. 17, 2010.
(60) Provisional application No. 61/439,913, filed on Feb. 6, 2011.
(60) Provisional application No. 61/447,089, filed on Feb. 27, 2011.
(60) Provisional application No. 61/447,464, filed on Feb. 28, 2011.
(60) Provisional application No. 61/467,209, filed on Mar. 24, 2011.
(60) Provisional application No. 61/867,007, filed on Aug. 16, 2013.
(60) Provisional application No. 61/924,252, filed on Jan. 7, 2014.
(60) Provisional application No. 61/916,190, filed on Dec. 14, 2013.
(60) Provisional application No. 61/927,481, filed on Jan. 15, 2014.
(60) Provisional application No. 61/953,878, filed on Mar. 16, 2014.
(60) Provisional application No. 61/972,314, filed on Mar. 30, 2014.
(60) Provisional application No. 62/023,800, filed on Jul. 11, 2014.
(60) Provisional application No. 61/352,166, filed on Jun. 7, 2010.
(60) Provisional application No. 61/388,002, filed on Sep. 30, 2010.
(60) Provisional application No. 61/414,451, filed on Nov. 17, 2010.
(60) Provisional application No. 61/439,913, filed on Feb. 6, 2011.
(60) Provisional application No. 61/447,089, filed on Feb. 27, 2011.
(60) Provisional application No. 61/447,464, filed on Feb. 28, 2011.
(60) Provisional application No. 61/467,209, filed on Mar. 24, 2011.

(51) Int. Cl. G06K 9/00; H04L 12/58

(52) U.S. Cl. CPC G06K 9/00315; G06K 9/00255; G06K 9/00288; H04L 51/02

(57) ABSTRACT

Expression analysis is performed via a background process and provided to foreground applications that register for emotion services. The foreground services are provided notification when a particular, previously determined emotional state is detected. The emotional state can be identified using facial feature analysis and/or gesture analysis. Upon receiving the notification of the state from the background process, the foreground services perform an emotion response action. The emotion response action can include sending a reply message indicating that a desired emotional response has been detected, providing a reward, and/or generating an automatic like on a social media system.

### RELATED APPLICATIONS

This application claims the benefit of U.S. provisional patent applications “Background Analysis of Mental State Expressions” Ser. No. 61/972,314, filed Mar. 30, 2014, “Mental State Event Definition Generation” Ser. No. 62/023,800, filed Jul. 11, 2014, “Facial Tracking with Classifiers” Ser. No. 62/047,508, filed Sep. 8, 2014, “Semiconductor Based Mental State Analysis” Ser. No. 62/082,579, filed Nov. 20, 2014, and “Viewership Analysis Based On Facial Evaluation” Ser. No. 62/128,974, filed Mar. 5, 2015. This application is also a continuation-in-part of U.S. patent application “Mental State Analysis Using Web Services” Ser. No. 13/153,745, filed Jun. 6, 2011, which claims the benefit of U.S. provisional patent applications “Mental State Analysis Through Web Based Indexing” Ser. No. 61/352,166, filed Jun. 7, 2010, “Measuring Affective Data for Web-Enabled Applications” Ser. No. 61/388,002, filed Sep. 30, 2010, “Sharing Affect Across a Social Network” Ser. No. 61/414,451, filed Nov. 17, 2010, “Using Affect Within a Gaming Context” Ser. No. 61/439,913, filed Feb. 6, 2011, “Recommendation and Visualization of Affect Responses to Videos” Ser. No. 61/447,089, filed Feb. 27, 2011, “Video Ranking Based on Affect” Ser. No. 61/447,464, filed Feb. 28, 2011, and “Baseline Face Analysis” Ser. No. 61/467,209, filed Mar. 24, 2011. This application is also a continuation-in-part of U.S. patent application “Mental State Analysis Using an Application Programming Interface” Ser. No. 14/460,915, Aug. 15, 2014, which claims the benefit of U.S. provisional patent applications “Application Programming Interface for Mental State Analysis” Ser. No. 61/867,007, filed Aug. 16, 2013, “Mental State Analysis Using an Application Programming Interface” Ser. No. 61/924,252, filed January 7, 2014, “Heart Rate Variability Evaluation for Mental State Analysis” Ser. No. 61/916,190, filed Dec. 14, 2013, “Mental State Analysis for Norm Generation” Ser. No. 61/927,481, filed Jan. 15, 2014, “Expression Analysis in Response to Mental State Express Request” Ser. No. 61/953,878, filed Mar. 16, 2014, “Background Analysis of Mental State Expressions” Ser. No. 61/972,314, filed Mar. 30, 2014, and “Mental State Event Definition Generation” Ser. No. 62/023,800, filed Jul. 11, 2014; the application is also a continuation-in-part of U.S. patent application “Mental State Analysis Using Web Services” Ser. No. 13/153,745, filed Jun. 6, 2011, which claims the benefit of U.S. provisional patent applications “Mental State Analysis Through Web Based Indexing” Ser. No. 61/352,166, filed Jun. 7, 2010, “Measuring Affective Data for Web-Enabled Applications” Ser. No. 61/388,002, filed Sep. 30, 2010, “Sharing Affect Across a Social Network” Ser. No. 61/414,451, filed Nov. 17, 2010, “Using Affect Within a Gaming Context” Ser. No. 61/439,913, filed Feb. 6, 2011, “Recommendation and Visualization of Affect Responses to Videos” Ser. No. 61/447,089, filed Feb. 27, 2011, “Video Ranking Based on Affect” Ser. No. 61/447,464, filed Feb. 28, 2011, and “Baseline Face Analysis” Ser. No. 61/467,209, filed Mar. 24, 2011. The foregoing applications are each hereby incorporated by reference in their entirety.

### FIELD OF ART

This application relates generally to analysis of mental states and more particularly to background analysis of mental state expressions.

### BACKGROUND

An individual's mental state is often reflected by the individual's facial expressions. For example, feelings of happiness often result in smiles, and feelings of frustration often result in frowns. The use of the term “facial expressions” refers to movements of the musculature of the face. Various muscles control the movement of the face, scalp, and outer ear, enabling a wide variety of facial expressions. The upper eyelid also plays a role in various facial expressions, such as expressions of surprise, fear, and anger. The expression evidenced by an individual in response to a particular mental state is referred to as emotional signaling. For example, an individual might express anger by furrowing his or her brow and tightening his or her lips while also displaying teeth, a set of actions which, when considered together, are part of an attack response. Similarly, a user might also express disgust with an open mouth, a nose wrinkle, and a tongue protrusion as part of a vomiting response. In addition, facial expressions can be part of expressive regulation, where the use of the facial muscles serves to regulate emotional signals being output by an individual. Facial expressions can also be a sign of cognition; the expressions can indicate that an individual is experiencing a state of concentration, recollection, or confusion, among others.

On any given day, an individual is confronted with a dizzying array of external stimuli. The stimuli can be any combination of visual, aural, tactile, and other types of stimuli, and, alone or in combination, can invoke strong emotions in the individual. An individual's reactions to received stimuli provide glimpses into the fundamental identity of the individual. Further, the individual's responses to the stimuli can have a profound impact on the mental states experienced by the individual. The mental states of an individual can vary widely, ranging from happiness to sadness, from contentedness to worry, and from calm to excitement, to name only a very few possible states.

An individual's mental or emotional state can also determine how the individual interprets external stimuli. For example, studies have been conducted showing that people find a given cartoon more humorous when watching the cartoon with an intentional smile as opposed to an intentional frown. That is, an expression of an emotional state, even if the expression is forced or contrived, can impact how a particular external event is perceived. Further, other studies have been performed suggesting that briefly forced smiling during periods of stress can help reduce a person's physical stress response, regardless of whether or not the person actually feels happy or not.

Thus, a complex relationship exists between physical and mental states. Additionally, how an experience is perceived can depend at least in part on the mental state of an individual at the time of the experience. For example, common experiences such as watching movies and television shows, dining at restaurants, playing games, taking classes, and work-related activities can all be perceived differently depending on the mental state of the individual. How an individual handles unforeseen or unexpected circumstances such as a traffic jam, a delayed flight, or a surprise visitor is also impacted by the individual's current mental/emotional state. As already noted, an individual might be able to influence their own mental state by forcing certain physiological actions, such as smiling. Therefore mental state analysis has a wide range of applications in medical, psychological, and commercial environments.

### SUMMARY

The mental state or states of a plurality of people are analyzed in a background process, and one or more foreground applications receive notification upon a detected occurrence of certain mental state expressions. The monitoring and notifying provides considerable flexibility for applications to take advantage of emotion services without having to actually implement the emotion services within the foreground application. Thus the emotion analysis is decoupled from the foreground applications that use the emotion services. The foreground applications can include messaging applications, social media applications, computerized training applications, and automated help applications, to name a few. A computer-implemented method for analysis is disclosed comprising: determining an expression to be detected on one or more devices; monitoring, by background process on the one or more devices, for the expression; identifying an occurrence of the expression; and providing notification that the expression was identified. In embodiments, the enabling of emotion services is accomplished using the one or more devices. In some embodiments, performing an emotion response action is accomplished in response to the provided notification. In embodiments, a computer program product embodied in a non-transitory computer readable medium for mental state analysis comprises: code for determining an expression to be detected on one or more devices; code for monitoring, by background process on the one or more devices, for the expression; code for identifying an occurrence of the expression; and code for providing notification that the expression was identified. In some embodiments, a computer system for mental state analysis comprises: a memory which stores instructions; one or more processors attached to the memory wherein the one or more processors, when executing the instructions which are stored, are configured to: determine an expression to be detected on one or more devices; monitor, by background process on the one or more devices, for the expression; identify an occurrence of the expression; and provide notification that the expression was identified.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for expression analysis.

FIG. 2 is a flow diagram for background expression analysis.

FIG. 3 shows an image collection system for facial analysis.

FIG. 4 shows example mental state data capture from multiple devices.

FIG. 5 shows an embodiment using a messaging application.

FIG. 6 shows an embodiment using an automated help application.

FIG. 7 shows example facial data collection including landmarks.

FIG. 8 is a flow for detecting facial expressions.

FIG. 9 is a flow for the large-scale clustering of facial events.

FIG. 10 shows example unsupervised clustering of features and characterizations of cluster profiles.

FIG. 11A shows example tags embedded in a webpage.

FIG. 11B shows example of invoking tag to collect images.

FIG. 12 is a system diagram for mental state analysis for expressions.

### DETAILED DESCRIPTION

On any given day, people can experience a range of mental states as they sense and react to external stimuli. The external stimuli can be experienced through the primary senses, including sight, smell, touch, hearing, and taste, as well as through other senses including balance, temperature, pain, and so on. The external stimuli can be naturally generated and can be experienced as the people interact with the world around them. Examples of naturally generated external stimuli can include, for example, the view of a beautiful panorama from a mountain peak, a sunset on a deserted beach, the sighting of a rare bird or animal, and so on. The external stimuli can also be human-generated. Examples of human-generated external stimuli can include artworks or installations, sports events, and various media such as movies, videos, television, advertisements, and so on. Regardless of whether a source of external stimuli is natural or human-generated, people can be monitored and data can be collected regarding the people's reactions to the external stimulus or stimuli. In turn, the data gathered from the people can be analyzed to determine one or more mental states. The data gathered from the people can include visual cues such as facial expressions, posture, and so on, and can also include physiological data such as heart rate. Based on the people's determined mental states, the effectiveness of a media presentation or another stimulus can be evaluated and compared to the effectiveness of other media presentations, for example. Media comparisons and evaluations can be used to improve the effectiveness of a given media presentation and the ability of the media presentation to influence the people viewing it. That is, a media presentation can have positive effects on the people viewing it. As previously mentioned, studies suggest that the physical act of smiling improves a person's mood. Given this, a person who reacts to the viewing of a media presentation with a smile can experience the positive effect of smiling, such as an overall improvement in mood.

The mental states experienced by people exposed to various stimuli can range widely and can include sadness, stress, happiness, anger, frustration, confusion, disappointment, hesitation, cognitive overload, focusing, engagement, attention, boredom, exploration, confidence, trust, delight, disgust, skepticism, doubt, satisfaction, excitement, laughter, calmness, and curiosity, for example. The mental states can be determined by gathering various data from the people as they experience the stimuli. For example, mental states can be determined by examining the people for visual cues such as eyebrow raises or eyebrow furrows, smiles or frowns, etc. The mental states can also be determined by monitoring physiological data such as heart rate, heart rate variability, skin temperature, electrodermal conductance, and so on. The mental states of the people can be analyzed using a range of devices including mobile devices, smart phones, tablet computers, laptop computers, desktop computers, and so on. Increasingly, other devices can also be used to determine mental states. The additional devices which can be used include “intelligent” devices such as smart televisions, Internet-connected devices found in a smart home, and so on.

Mental state analysis can be used to determine the one or more mental states of a person as he or she performs various tasks. The person's mental state can be analyzed for a variety of purposes. For example, a person might be asked to comply with a request for the express purpose of monitoring the mental state or states of the person. In another example, the person can be offered an incentive for complying with the request. The person might be using an application that has been registered for emotion services. The application can register with a background process to receive notifications when a particular mental state expression is invoked by the user. The mental state expression can include one or more of a smile, a frown, an eyebrow raise, an eyebrow furrow, and so on. Such mental state analysis can be used to gauge the response of the person to the request. Based on the response of the person to the request, that is, the level of correspondence between the individual's mental state expression and the parameters outlaid by the request, the person can be rewarded for the effectiveness of his or her mental state expression. In other embodiments, a person uses a messaging application, such as an e-mail or text message application, to read a message from a friend that makes them smile. The messaging application, having been registered for emotion services, receives notification of the user evidencing a happy mental state shortly after the user accesses the message, and thus sends a reply message to the sender indicating that the recipient was happy upon reading the message. In certain embodiments, the response message also includes an image of how the user looked upon reading the message. To facilitate the identification of mental states, cameras on devices can track eye movements to make an estimation and/or determination of when the message has been read.

The mental state analysis that can be used to determine the one or more mental states of a person can be based on passive, as well as active, monitoring of the person. Various devices can be used for the monitoring, including mobile devices, smart phones, PDAs, tablet computers, laptop computers, desktop computers, and so on. The devices that can be used for the monitoring can also include “intelligent” devices such as smart televisions, Internet-connected devices, wireless digital consumer devices, and so on. The devices can be executing a variety of tasks simultaneously or individually, including foreground tasks and background tasks. The foreground tasks can include applications and apps such as front office software, research and academic software, and so on. The foreground tasks can also include entertainment applications such as video and music streaming, games, and so on. The background tasks can include operating systems, updates to calendars and software, and so on. The background tasks can also include monitoring applications. Foreground tasks and background tasks can be operating simultaneously. So, for example, a person can be viewing a video using a foreground task while a monitoring task is operating in the background. The devices can use the monitoring tasks operating in the background to monitor the person for mental state expressions while the person is viewing the video or performing another action, for example. The monitoring devices can gather data from the person. The data that can be gathered can include video data, audio data, temperature data, and so on. In embodiments, a background process monitors the mental state of a user. One or more foreground applications that wish to take advantage of emotion services can register for notifications from the background process. In turn, the background process continuously or periodically monitors the expressions and/or gestures of the user. When the user invokes a predetermined mental state (e.g. confusion), a notification can be sent to a foreground application, which can then perform an emotion response action. The emotion response action depends on the type and purpose of the foreground application, and can include, but is not limited to, sending a reply message, providing a reward, and/or generating an automatic like on a social media system.

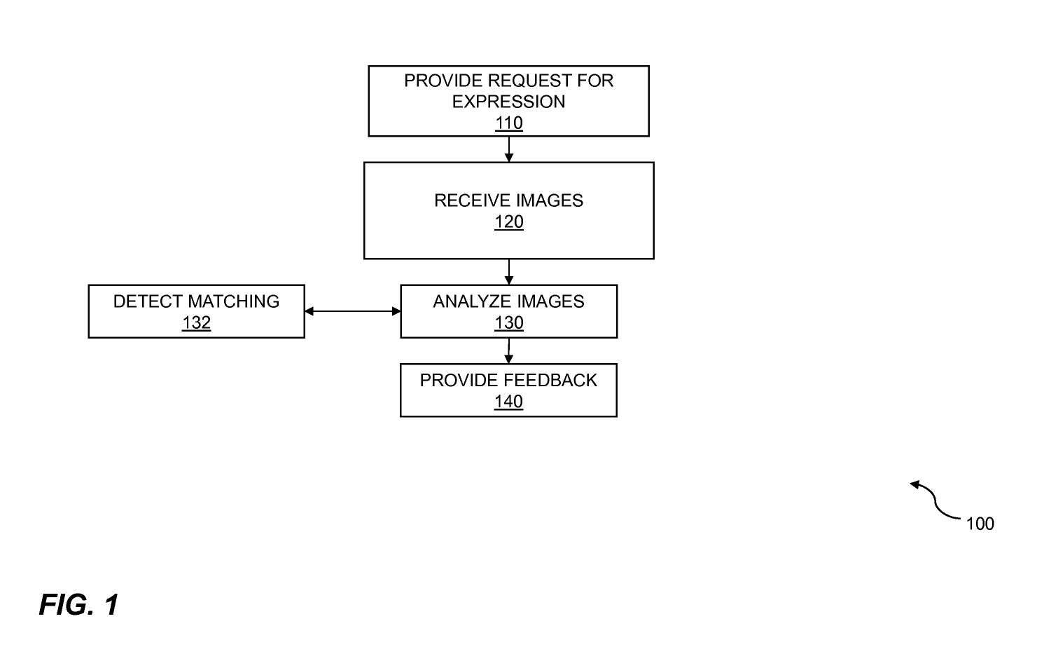

FIG. 1 is a flow diagram for expression analysis. The flow 100 describes a computer-implemented method for mental state analysis comprising providing a request to a user for a certain expression 110, receiving one or more images 120 from the user in response to the request, analyzing the images 130 to detect matching 132 between the request and the response, and providing feedback 140 based on the analyzing. The request can be a function of a mental state. The mental state can be one or more of frustration, confusion, disappointment, hesitation, cognitive overload, focusing, engagement, exploration, confidence, trust, delight, disgust, skepticism, doubt, satisfaction, excitement, laughter, calmness, sadness, stress, anger, happiness, and curiosity. The feedback can include a reward. The reward can include a coupon. The coupon can include a digital coupon. The reward can include currency. The currency can include a virtual currency. Various steps in the flow 100 may be changed in order, repeated, omitted, or the like without departing from the disclosed concepts. Various embodiments of the flow 100 may be included in a computer program product embodied in a non-transitory computer readable medium that includes code executable by one or more processors.

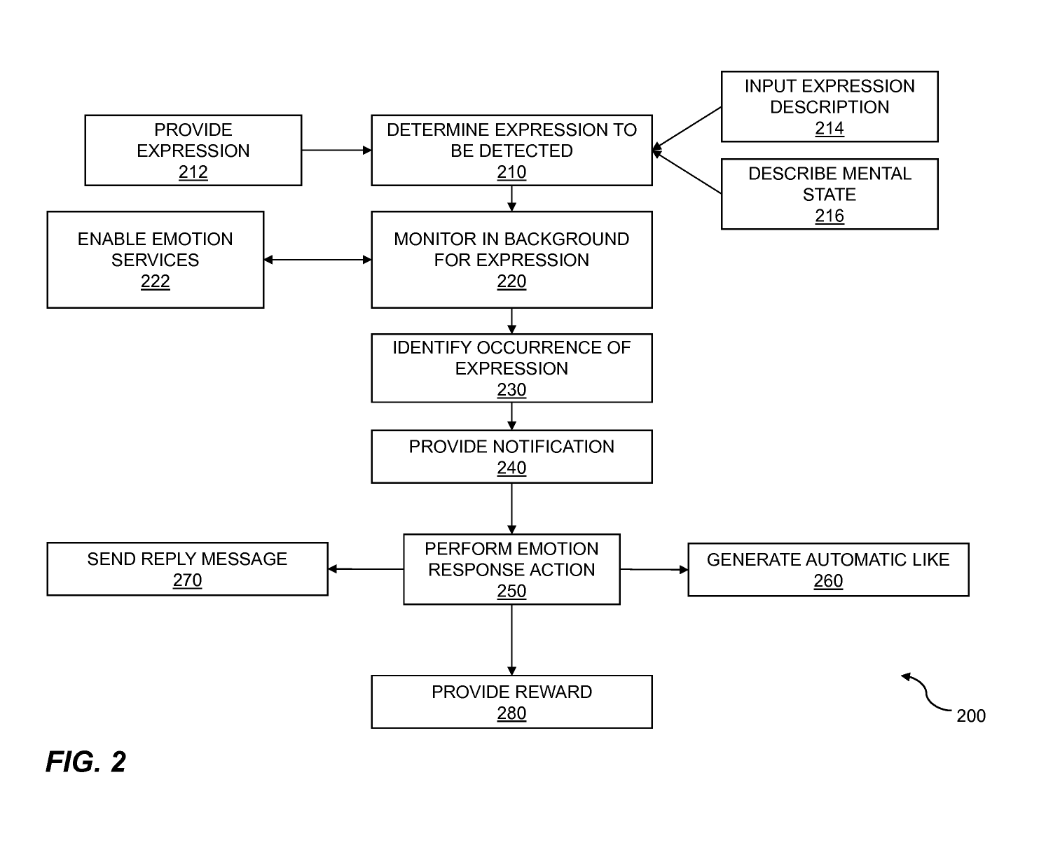

FIG. 2 is a flow diagram 200 for background expression analysis. The flow starts with determining an expression to be detected 210. The expression can include, but is not limited to, joy, happiness, confusion, anger, frustration, boredom, and/or sadness. The expression to be detected can depend on the application performing the requesting. For example, an automated help application can invoke an automated help system upon detection of an expression of confusion. An expression of the type to be detected can be provided 212. That is, in embodiments, the determining is accomplished at least in part by the providing an expression to the system for matching purposes. The providing an expression can be via an image. For example, a user or system administrator can upload pictures and/or illustrations of the types of expressions the application should detect. Alternatively, an expression description is input 214 and/or a mental state is described 216 in order to specify the expression or expressions to be detected. Thus, in some embodiments, the determining is accomplished by describing a mental state. A user can select, via a user interface, one or more expressions that are to be detected. For example, a user might select confusion and frustration as the expressions to be detected for an embodiment where an automated help application is triggered when a user experiences confusion and frustration. Furthermore, in some embodiments, the determining is accomplished by inputting an expression description. In some embodiments, the inputting of the expression description 214 includes specifying one or more facial action coding system (FACS) codes. The codes can include one or more action units (Ails) in order to specify particular aspects of a facial expression that is to be detected.

The flow continues with monitoring in the background for an expression 220. The monitoring can be performed with a background application, one or more processes within an application, one or more threads within an application, and/or a dedicated processor or processors. While various embodiments are possible for implementing the background monitoring, hereinafter the entity performing the monitoring will be referred to as a “background process.” The background process can have access to one or more camera sensors. In embodiments, a camera sensor is continuously active as part of the monitoring. The background process can be started by enabling emotion services 222. In embodiments, the emotion services are provided on a device. The device can include, but is not limited to, a computer, mobile phone, and/or tablet computer. Embodiments include enabling emotion services using the one or more devices. The emotion services can include detecting smiles, expressions, frowns, heart rate, eyebrow raises, brow furrows, concentration, being expressive, and laughing. In embodiments, applications use the enabling. Applications can include, but are not limited to, messaging applications, social media applications, and online help applications.

The flow continues with identification of an occurrence of the specified expression or expressions 230. In embodiments, the identifying is provided with a confidence interval. For example, an expression of confusion can be identified by positions of eyebrows, lip corners, and brows. If a user invokes a facial expression with all three of these facial components in the confused pattern, then the confidence interval can be determined to be high (e.g. 90 percent range). If the user instead invokes a facial expression where the brow and eyebrows indicate confusion, but the lip corners do not, then the confidence interval might be lower (e.g. 70 percent range). In embodiments, the expression is a reflection of a mental state. The flow continues with providing notification 240. In embodiments, a foreground application receives the providing of the notification. The notification can be provided to one or more foreground applications. In embodiments, a subscriber callback mechanism can be used. In some embodiments, the applications call an application programming interface (API) to specify a desired expression and to register a callback function with the background process. The background process maintains a list of expressions and callback functions. When a given expression is detected, each registered callback function is executed to provide notification to the respective foreground applications. In other embodiments, remote procedure calls can be used to provide notification. In embodiments, the confidence interval is reported in the notification. In this way, the foreground application can use the confidence interval in deciding what course of action to take based on the notification. For example, an application might invoke an automatic help dialog box if a user appears confused and the user's expression of confusion exceeds a given confidence interval, but ignore the user's expression of confusion if it falls below the determined confidence interval.

The flow continues with performing a response action 250. The response action 250 can include, but is not limited to, sending a reply message 270 to a sender. In one embodiment, the reply message shows the sender an emotion that the recipient experienced upon reading the sender's message. In another embodiment, the response action includes generating an automatic like 260. A like-generating embodiment can be ideal for social media systems where participants can “like” content on the social media system. In a social media context, a “like” is an indication of favorability that can get recorded in the social media system. The social media system might keep track of likes received by, as well as who has liked, a particular piece of content. In a typical social media system, a user clicks a button or icon on the social media user interface in order to provide a like. In embodiments, the generating of an automatic like includes detecting a positive emotion while a user views a piece of social media content and attributing a like to the content on the user's behalf. In yet other embodiments, the providing includes delivering a coupon or a reward 280. The reward can include a coupon, virtual currency, currency, or another suitable gift. In embodiments, the providing is part of a gaming experience. For example, while playing an online multiplayer battle game, a user might earn a reward for providing a “fierce battle” expression. Embodiments can include one or more of sending a reply message, generating an automatic like, or providing a reward, as part of the emotion response action. Other emotion response actions are possible, including, but not limited to, adjusting lights in a room, adjusting room temperature, and adjusting music genre and/or music volume in a room, in response to detecting a particular emotion. Thus, in embodiments, a foreground application receives the providing of the notification, thereby enabling emotion services using the one or more devices and opening the possibility of performing an emotion response action in response to the provided notification.

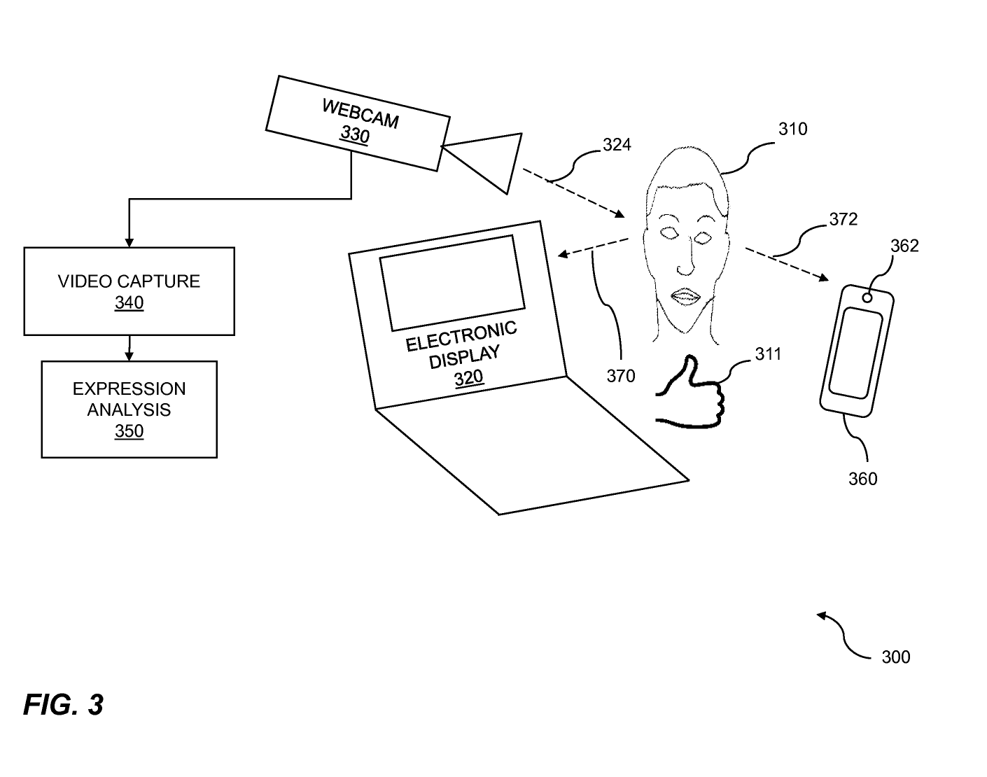

FIG. 3 is an image collection system for facial analysis. An individual 310 can view on a line of sight 370 an electronic display 320, and mental state data on the individual 310 can be collected and analyzed. The electronic display 320 can show an output of a computer application that the individual 310 is using, or the electronic display 320 can show a media presentation so that the individual 310 is exposed to the media presentation. The display 320 can be any electronic display, including but not limited to, a computer display, a laptop screen, a net-book screen, a tablet screen, a cell phone display, a mobile device display, a remote with a display, a television, a projector, or the like. Likewise, other electronic displays such as a mobile device 360 showing the media presentation or another presentation can be viewed by the individual 310 on another line of sight 372. While viewing the media presentation, the individual 310 can be monitored by a camera 330 on another line of sight 324. The media presentation can include one of a group consisting of a movie, a television show, a web series, a webisode, a video, a video clip, an electronic game, an e-book, or an e-magazine. The electronic display 320 can be a part of, or can be driven by, the device collecting the mental state data, or the electronic display might only be loosely coupled with, or even unrelated to, the device collecting the mental state data, depending on the embodiment. The collecting can be accomplished with a mobile device 360 such as a cell phone, a tablet computer, or a laptop computer, and the mobile device can include a forward facing camera 362. Facial data on the individual 310 can be collected with a camera such as the forward facing camera 362 of the mobile device 360 and the webcam 330. Additionally, the individual 310 can make one or more gestures 311 as part of answering the request for generating an emotional response. The webcam 330 can be configured to acquire images of the gesture 311 and the gesture 311 can be analyzed as part of the expression analysis 350. Vision-based gestural analysis can utilize recognition of static hand gestures or body postures. The imaging techniques used in the analysis can include, but are not limited to, identification of contours and silhouettes, and/or generation of 3D hand skeleton models. In various embodiments, the 3D hand models utilize non-uniform rational basis spline (NURBS) or polygon meshes. Embodiments can also utilize simple 3D geometric structures to model the human body. Structures like generalized cylinders and super-quadrics, which encompass cylinders, spheres, ellipsoids and hyper-rectangles, can be used to approximate the shape of simple body parts, such as fingers, a thumb, a forearm, and/or the upper arm portions of limbs. In embodiments, the gestures are identified utilizing a DTW (dynamic time warping) pattern recognizer and/or a Hidden Markov Model (HMM) recognizer.

The video can be obtained using a webcam 330. The video can be obtained from multiple sources, and in some embodiments, at least one of the multiple sources is a mobile device. The expression information can be collected intermittently when the individual 310 is looking in the direction of a camera, such as the forward facing mobile camera 362 or the webcam 330. The camera can also capture images of the setting in which a user is found, images which can be used in determining contextual information.

The webcam 330 can capture video, audio, and/or still images of the individual 310. A webcam, as the term is used herein, can include a video camera, a still camera, a thermal imager, a CCD device, a phone camera, a three-dimensional camera, a depth camera, multiple webcams used to show different views of a person, or any other type of image capture apparatus that can allow captured data to be used in an electronic system. The images of the individual 310 from the webcam 330 can be processed by a video capture unit 340. In some embodiments, video is captured, while in other embodiments, one or more still images are captured by the unit 340. The system 300 can include analyzing the video for expressions 350, facial data, and/or physiological data. The facial data can include information on facial expressions, action units, head gestures, smiles, smirks, brow furrows, squints, lowered eyebrows, raised eyebrows, or attention, in various embodiments. Analysis of physiological data can also be performed based on the video. Respiration, heart rate, heart rate variability, perspiration, temperature, and other physiological indicators of mental state can be determined by analyzing the video.

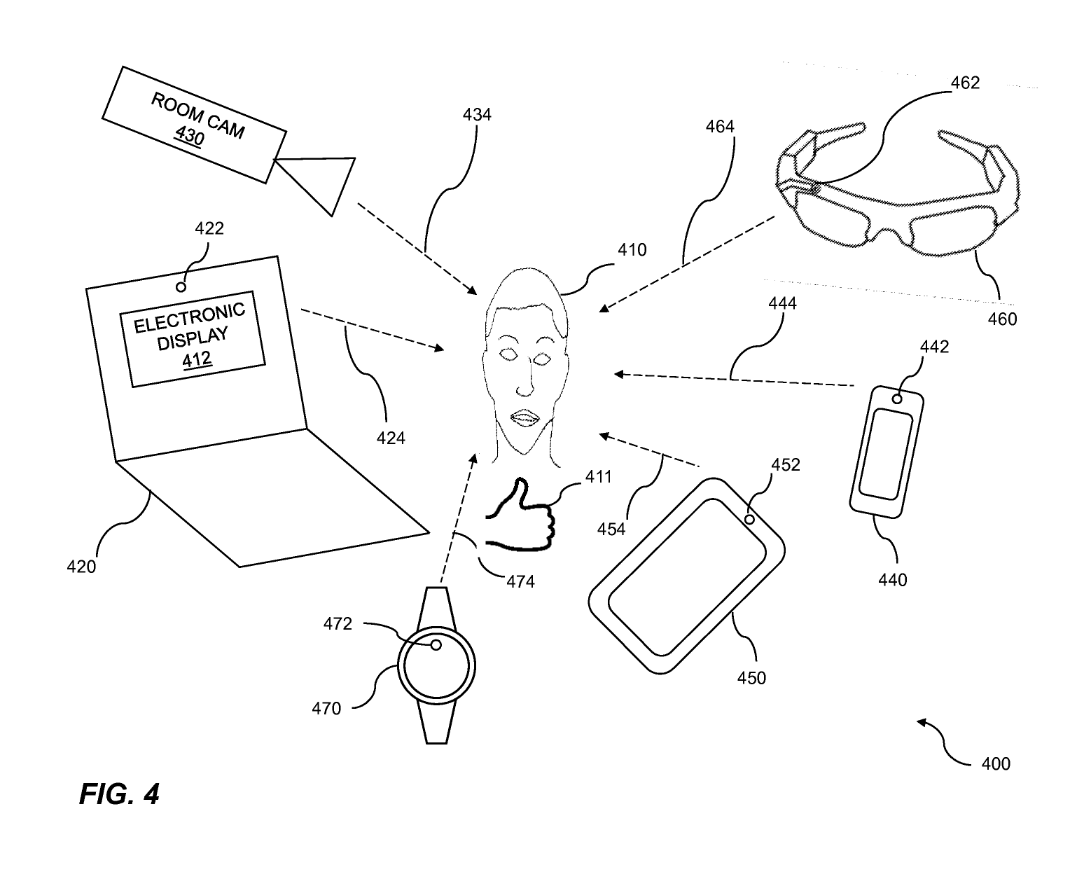

FIG. 4 shows a diagram 400 illustrating example mental state data capture from multiple devices. Expressions can be determined based on mental state data collected from multiple devices and, additionally, the mental state data can be obtained from multiple sources. At least one of the multiple sources can be a mobile device. Thus, facial data can be collected from a plurality of sources and used for mental state analysis. A user 410 can be performing a task, viewing a media presentation on an electronic display 412, or doing any activity where it can prove useful to determine the user's mental state. The electronic display 412 can be on a laptop computer 420 as shown, a tablet computer 450, a mobile phone 440, a desktop computer monitor, a television, or any other type of electronic device. One or more of the devices shown in the diagram 400, such as the tablet computer 450, the phone 440, and/or the laptop computer 420 can execute a background process for background analysis of mental state expressions. In embodiments, the monitoring comprises a background operation within the one or more devices. In embodiments, the monitoring is accomplished passively. That is, there are no special actions required by the user, or special requests given to the user to collect mental state data. In such embodiments, the one or more devices can monitor the user using camera sensors, microphones, and/or other types of sensors as he or she goes about performing an activity (e.g. using a particular foreground application).

The mental state data can be collected on a mobile device such as the mobile phone 440, the tablet computer 450, or the laptop computer 420; a fixed device, such as a room camera 430; or a wearable device such as glasses 460 or a watch 470. In various embodiments, the glasses 460 are virtual reality glasses or augmented reality glasses. Virtual reality glasses can render a scene to elicit a mental state from the user 410. The plurality of sources can include at least one mobile device such as the mobile phone 440 or the tablet computer 450, or a wearable device such as the glasses 460 or the watch 470. A mobile device can include a forward facing camera and/or rear facing camera, both of which can be used to collect video and/or image data. In embodiments, the room camera 430 comprises a video capture device for capturing multiple images in rapid succession and includes a depth sensor to provide 3D motion capture. In embodiments, the depth sensor comprises an infrared laser projector. In embodiments, the room camera 430 also provides gesture recognition capabilities.

As the user 410 is monitored, the user 410 can move due to the nature of the task, boredom, distractions, or for another reason. As the user moves, the user's face can be visible from one or more of the multiple sources. For example, if the user 410 is looking in a first direction, the user's face might be within the line of sight 424 of the webcam 422, but if the user is looking in a second direction, the user's face might be within the line of sight 434 of the room camera 430. Further, if the user is looking in a third direction, the user's face might be within the line of sight 444 of the phone camera 442, and if the user is looking in a fourth direction, the user's face might be within the line of sight 454 of the tablet camera 452. Continuing, if the user is looking in a fifth direction, the user's face might be within the line of sight 464 of the wearable camera 462, and if the user is looking in a sixth direction, the user's face might be within the line of sight 474 of the other wearable camera 472. Another user or an observer can wear the wearable device, such as the glasses 460 or the watch 470. In other embodiments, the wearable device is a device other than glasses, such as an earpiece with a camera, a helmet or hat with a camera, a clip-on camera attached to clothing, or any other type of wearable device with a camera or another sensor for collecting mental state data. The user 410 can also wear a wearable device including a camera which can be used for gathering contextual information and/or collecting mental state data on other users. Because the user 410 can move his or her head, the facial data can be collected intermittently when the user 410 is looking in the direction of a camera. In some cases, multiple people are included in the view from one or more cameras, and some embodiments include filtering out faces of one or more other people to determine whether the user 410 is looking toward a camera. An expression can thus be identified using mental state data collected by various devices. Expressions can be analyzed from the various devices collectively on mental state data combined from multiple devices. The devices are shown for illustration purposes only, and other devices, such as a smart refrigerator, can be used as well. Additionally, the individual 410 can make one or more gestures 411 as part of answering the request for generating an emotional response. The camera 430 can be configured to acquire images of the gestures 411 and the gestures 411 can be analyzed as part of the expression analysis.

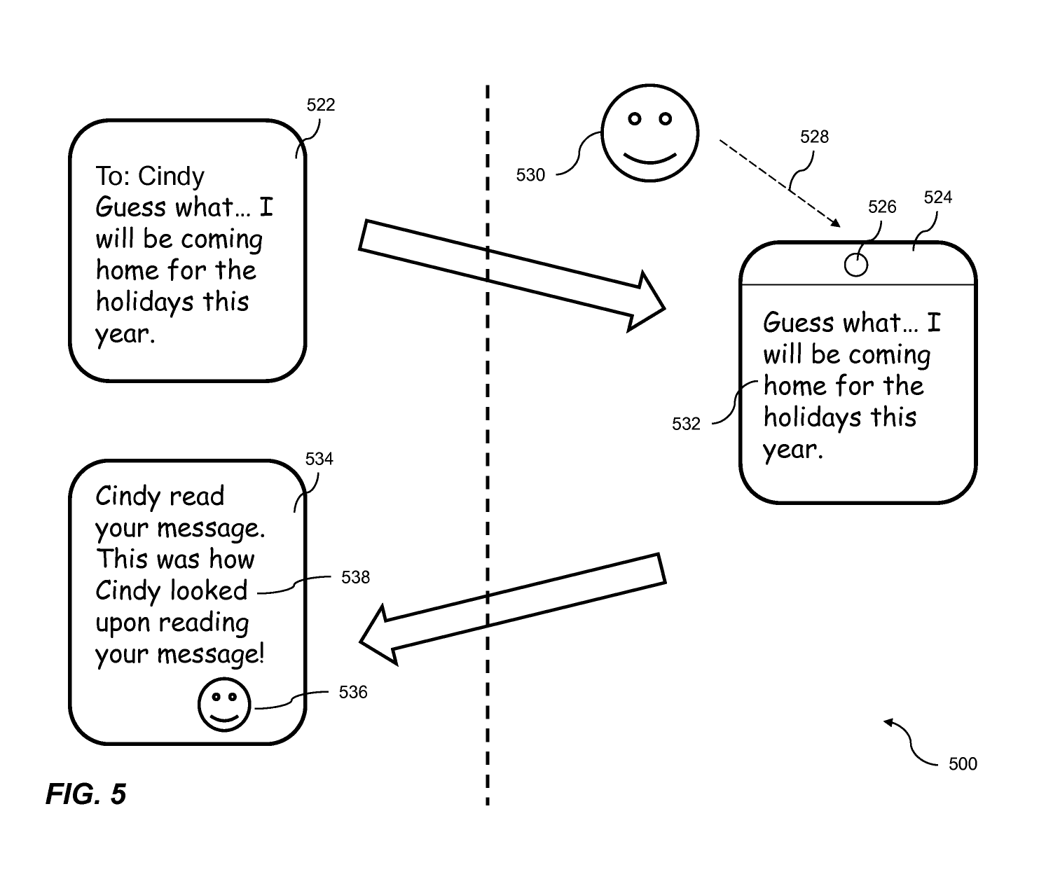

FIG. 5 shows an embodiment 500 using a messaging application. In a messaging embodiment, a background process monitors the emotional state of a user as the user reads messages. Upon detecting a particular emotional state in the user, the background process can generate a reply message to be sent to the sender, indicating that the recipient experienced a particular mental state upon reading the message. Additionally the replay message can also include an image showing the recipient's reaction upon reading the message. The reply message can also include text indicating that the recipient read the message, and can further include text conveying the detected emotion. As shown in FIG. 5, a sender sends a message 522 to a recipient 530. The message can include, but is not limited to, an e-mail message, an SMS text message, an instant message, a chat, a social media post, or another electronic message type. In embodiments, the recipient 530 reads the received message 532 on his or her device 524, which includes a camera 526 that has a line of sight 528 to the recipient 530. Upon detecting a particular emotion such as joy, the background process can notify the messaging application (which is a foreground process), and the messaging application can then send a reply message 534 to the sender. In embodiments, the reply message 534 includes a text portion 538, and an image portion 536, the image portion comprising an image captured by the recipient's camera 526 upon detecting the desired emotion. In this way, users of the messaging system experience more deeply the emotions inherent in human communication by seeing the candid, instantaneous response of a recipient reading an electronic message. Note that while the embodiment described herein illustrates an automatic sending of a reply message with emotional state information of the recipient included, other embodiments ask the recipient if they wish to send the information. For example, if the background process detects a laugh while the user is reading a message, the recipient can be prompted with a message such as, “Something seems funny . . . Do you wish to share it with the sender?” Such an embodiment can promote a more fulfilling and entertaining messaging experience. Thus, in embodiments, the foreground application comprises a messaging application configured to send messages between a sender and a recipient, and, upon the recipient accessing a first message, the background process identifies an occurrence of the identified expression. Further, upon identifying an occurrence of the expression, the background process can instigate an emotion response action comprising, in embodiments, sending a second message to the sender including emotion scoring, wherein the second message is indicative of the recipient's emotional response to the first message. The second message can further include an image and/or an emoji. The emoji can include an emoticon or in some other way be a digital representation of a mood, emotion, or mental state.

In addition to messaging applications, embodiments also pertain to social media applications. For example, in a social media system, users can post various messages (also referred to as “posts”) to the system, which can be rendered on a website, within an application, or in another electronic format. As a user accesses (reads) the social media messages (posts), the background process on the user's device can monitor emotional states. In some embodiments, the foreground social media application on the user's device receives the emotional state notification from the background process, and, in response, posts a social media message indicating the user's emotional state. Thus, in embodiments, the foreground application comprises a social media application configured to display a first message, and, upon the recipient accessing the first message, allow a background process to determine an occurrence of the identified expression and perform an emotional response action. The emotion response action can include posting a second message which comprises emotion scoring on a social media system, and wherein the second message is indicative of the recipient's emotional response to the first message. In other embodiments, the social media system can generate an automatic “like” of the post if a positive emotional state (e.g. laughter or joy) is detected. The second message can further include an image and/or an emoji. Thus, disclosed embodiments can enhance the social media experience. To summarize, embodiments include a foreground social media application configured to display a message to a user, and simultaneously allow a background process to determine an occurrence of a previously identified expression in the user and generate an emotion response action, such as an automatic like of the message, in response to the expression.

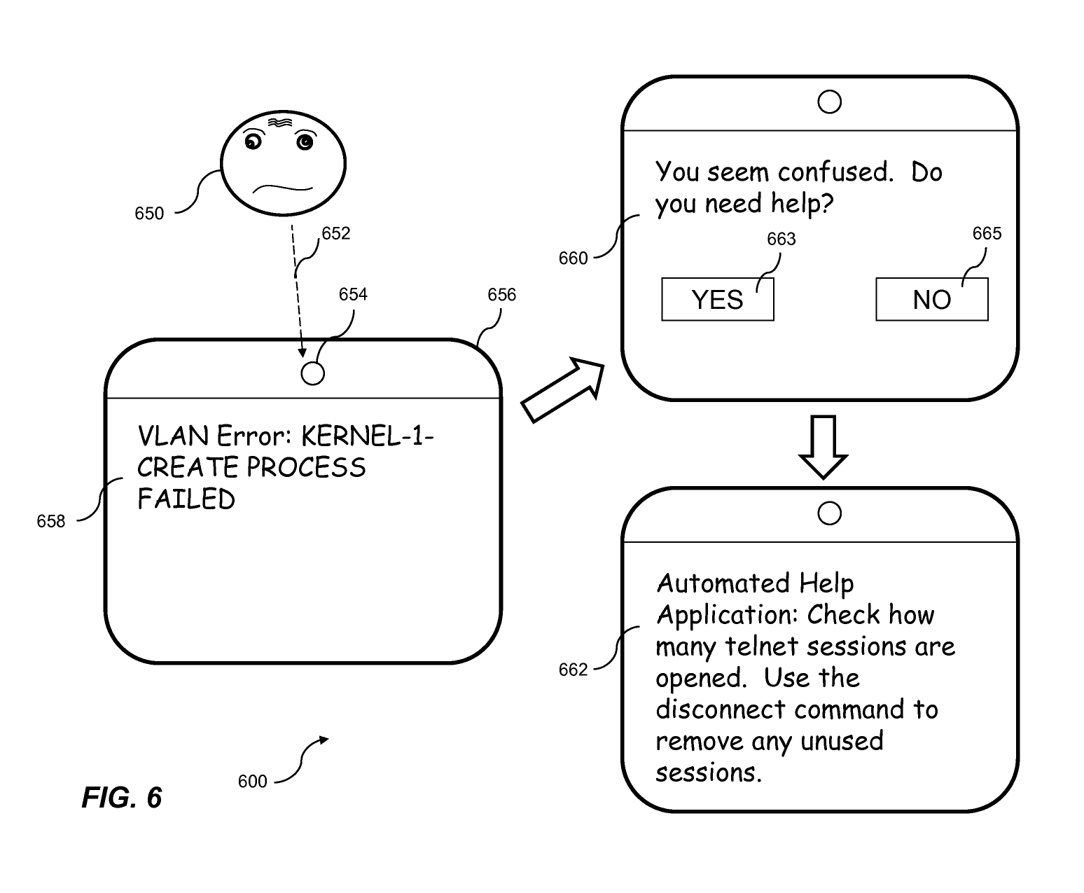

FIG. 6 shows an embodiment 600 using an automated help application. A user 650 is interacting with a foreground application on his or her device 656. The user 650 is within a line of sight 652 of a camera 654. A background process periodically monitors the emotional state of the user 650. If the user 650 receives feedback 658 from the foreground application with which he or she is interacting that causes an expression of confusion, the background process then can notify the foreground application that the user 650 is currently experiencing confusion. The foreground application can then invoke an automated help application. The automatic help application (function) can query the user in order to determine if the user needs help. For example, the user can be prompted using an automated help application message 660 such as, “You seem confused. Do you need help?” The user interface can present a YES button 663 and a NO button 665. If the user selects YES, then more detailed information about the user's current circumstances can be displayed in a detailed automated help application message 662. In this way, embodiments allow applications to anticipate user confusion and/or frustration and proactively provide help. Thus, in embodiments, the emotion response action includes invoking an automated help application.

The human face provides a powerful communications medium through its ability to exhibit a myriad of expressions that can be captured and analyzed for a variety of purposes. In some cases, media producers are acutely interested in evaluating the effectiveness of message delivery by video media. Such video media includes advertisements, political messages, educational materials, television programs, movies, government service announcements, etc. Automated facial analysis can be performed on one or more video frames containing a face in order to detect facial action. Based on the facial action detected, a variety of parameters can be determined including affect valence, spontaneous reactions, facial action units, and so on. The parameters that are determined can be used to infer or predict emotional and mental states. For example, determined valence can be used to describe the emotional reaction of a viewer to a video media presentation or another type of presentation. Positive valence provides evidence that a viewer is experiencing a favorable emotional response to the video media presentation, while negative valence indicates provides evidence that a viewer is experiencing an unfavorable emotional response to the video media presentation. Other facial data analysis can include the determination of discrete emotional states of the viewer or viewers.

Facial data can be collected from a plurality of people using any of a variety of cameras. A camera can include a webcam, a video camera, a still camera, a thermal imager, a CCD device, a phone camera, a three-dimensional camera, a depth camera, a light field camera, multiple webcams used to show different views of a person, or any other type of image capture apparatus that can allow captured data to be used in an electronic system. In some embodiments, the person is permitted to “opt-in” to the facial data collection. For example, the person can agree to the capture of facial data using a personal device such as a mobile device or another electronic device and can select an opt-in choice. Opting-in can then turn on the person's webcam-enabled device and can begin the capture of the person's facial data via a video feed from the webcam. The video data that is collected can include one or more persons experiencing an event. The one or more persons can be sharing a personal electronic device or can each be using one or more devices for video capture. The videos that are collected can be collected using a web-based framework. The web-based framework can be used to display the video media presentation or event as well as to collect videos from any number of viewers who are online. That is, the collection of videos can be crowdsourced from those viewers who elected to opt-in to the video data collection.

The videos captured from the various viewers who chose to opt-in can be substantially different in terms of video quality, frame rate, etc. As a result, the facial video data can be scaled, rotated, and otherwise adjusted to improve consistency. Human factors further play into the capture of the facial video data. The facial data that is captured might or might not be relevant to the video media presentation being displayed. For example, the viewer might not be paying attention, might be fidgeting, might be distracted by an object or event near the viewer, or otherwise inattentive to the video media presentation. The behavior exhibited by the viewer can prove challenging to analyze due to viewer actions including eating, speaking to another person or persons, speaking on the phone, etc. The videos collected from the viewers might also include other artifacts that pose challenges during the analysis of the video data. The artifacts can include such items as eyeglasses (because of reflections), eye patches, jewelry, and clothing that occludes or obscures the viewer's face. Similarly, a viewer's hair or hair covering can present artifacts by obscuring the viewer's eyes and/or face.

The captured facial data can be analyzed using the facial action coding system (FACS). The FACS seeks to define groups or taxonomies of facial movements of the human face. The FACS encodes movements of individual muscles of the face, where the muscle movements often include slight, instantaneous changes in facial appearance. The FACS encoding is commonly performed by trained observers, but can also be performed on automated computer-based systems. Analysis of the FACS encoding can be used to determine emotions of the persons whose facial data is captured in the videos. The FACS is used to encode a wide range of facial expressions that are anatomically possible for the human face. The FACS encodings include action units (AUs) and related temporal segments that are based on the captured facial expression. The AUs are open to higher order interpretation and decision-making For example, the AUs can be used to recognize emotions experienced by the observed person. Emotion-related facial actions can be identified using the emotional facial action coding system (EMFACS) and the facial action coding system affect interpretation dictionary (FACSAID), for example. For a given emotion, specific action units can be related to the emotion. For example, the emotion anger can be related to AUs 4, 5, 7, and 23, while happiness can be related to AUs 6 and 12. Other mappings of emotions to AUs have also been previously associated. The coding of the AUs can include an intensity scoring that ranges from A (trace) to E (maximum). The AUs can be used for analyzing images to identify patterns indicative of a particular mental and/or emotional state. The AUs range in number from 0 (neutral face) to 98 (fast up-down look). The AUs include so-called main codes (inner brow raiser, lid tightener, etc.), head movement codes (head turn left, head up, etc.), eye movement codes (eyes turned left, eyes up, etc.), visibility codes (eyes not visible, entire face not visible, etc.), and gross behavior codes (sniff, swallow, etc.). Emotion scoring can be included where intensity is evaluated as well as specific emotions, moods, or mental states.

The coding of faces identified in videos captured of people observing an event can be automated. The automated systems can detect facial Ails or discrete emotional states. The emotional states can include amusement, fear, anger, disgust, surprise and sadness, for example. The automated systems can be based on a probability estimate from one or more classifiers, where the probabilities can correlate with an intensity of an AU or an expression. The classifiers can be used to identify into which of a set of categories a given observation can be placed. For example, the classifiers can be used to determine a probability that a given AU or expression is present in a given frame of a video. The classifiers can be used as part of a supervised machine learning technique where the machine learning technique can be trained using “known good” data. Once trained, the machine learning technique can proceed to classify new data that is captured.

The supervised machine learning models can be based on support vector machines (SVMs). An SVM can have an associated learning model that is used for data analysis and pattern analysis. For example, an SVM can be used to classify data that can be obtained from collected videos of people experiencing a media presentation. An SVM can be trained using “known good” data that is labeled as belonging to one of two categories (e.g. smile and no-smile). The SVM can build a model that assigns new data into one of the two categories. The SVM can construct one or more hyperplanes that can be used for classification. The hyperplane that has the largest distance from the nearest training point can be determined to have the best separation. The largest separation can improve the classification technique by increasing the probability that a given data point can be properly classified.

In another example, a histogram of oriented gradients (HOG) can be computed. The HOG can include feature descriptors and can be computed for one or more facial regions of interest. The regions of interest of the face can be located using facial landmark points, where the facial landmark points can include outer edges of nostrils, outer edges of the mouth, outer edges of eyes, etc. A HOG for a given region of interest can count occurrences of gradient orientation within a given section of a frame from a video, for example. The gradients can be intensity gradients and can be used to describe an appearance and a shape of a local object. The HOG descriptors can be determined by dividing an image into small, connected regions, also called cells. A histogram of gradient directions or edge orientations can be computed for pixels in the cell. Histograms can be contrast-normalized based on intensity across a portion of the image or the entire image, thus reducing any influence from illumination or shadowing changes between and among video frames. The HOG can be computed on the image or on an adjusted version of the image, where the adjustment of the image can include scaling, rotation, etc. For example, the image can be adjusted by flipping the image around a vertical line through the middle of a face in the image. The symmetry plane of the image can be determined from the tracker points and landmarks of the image.

In an embodiment, an automated facial analysis system identifies five facial actions or action combinations in order to detect spontaneous facial expressions for media research purposes. Based on the facial expressions that are detected, a determination can be made with regard to the effectiveness of a given video media presentation, for example. The system can detect the presence of the AUs or the combination of AUs in videos collected from a plurality of people. The facial analysis technique can be trained using a web-based framework to crowdsource videos of people as they watch online video content. The video can be streamed at a fixed frame rate to a server. Human labelers can code for the presence or absence of facial actions including symmetric smile, unilateral smile, asymmetric smile, and so on. The trained system can then be used to automatically code the facial data collected from a plurality of viewers experiencing video presentations (e.g. television programs).

Spontaneous asymmetric smiles can be detected in order to understand viewer experiences. The detection can be treated as a binary classification problem, where images that contain a right asymmetric expression are used as positive (target class) samples and all other images as negative (non-target class) samples. Classifiers perform the classification, including classifiers such as support vector machines (SVM) and random forests. Random forests can include ensemble-learning methods that use multiple learning algorithms to obtain better predictive performance. Frame-by-frame detection can be performed to recognize the presence of an asymmetric expression in each frame of a video. Facial points can be detected including the top of the mouth and the two outer eye corners. The face can be extracted, cropped and warped into a pixel image of specific dimension (e.g. 96×96 pixels). In embodiments, the inter-ocular distance and vertical scale in the pixel image are fixed. Feature extraction can be performed using computer vision software such as OpenCV™. Feature extraction can be based on the use of HOGs. HOGs include feature descriptors and are used to count occurrences of gradient orientation in localized portions or regions of the image. Other techniques can be used for counting occurrences of gradient orientation, including edge orientation histograms, scale-invariant feature transformation descriptors, etc. The AU recognition tasks can also be performed using Local Binary Patterns (LBP) and Local Gabor Binary Patterns (LGMP). The HOG descriptor represents the face as a distribution of intensity gradients and edge directions, and is robust in its ability to translate and scale. Differing patterns including groupings of cells of various sizes and arranged in variously sized cell blocks can be used. For example, 4×4 cell blocks of 8×8 pixel cells with an overlap of half of the block can be used. Histograms of channels can be used, including nine channels or bins evenly spread over 0-180 degrees. In this example, the HOG descriptor on a 96×96 image is 25 blocks×16 cells×9 bins=3600, the latter quantity representing the dimension. AU occurrences can be rendered. Related literature indicates that as many asymmetric smiles occur on the right hemi face as on the left hemi face as reported for spontaneous expressions. The videos can be grouped into demographic datasets based on nationality and/or other demographic parameters for further detailed analysis.

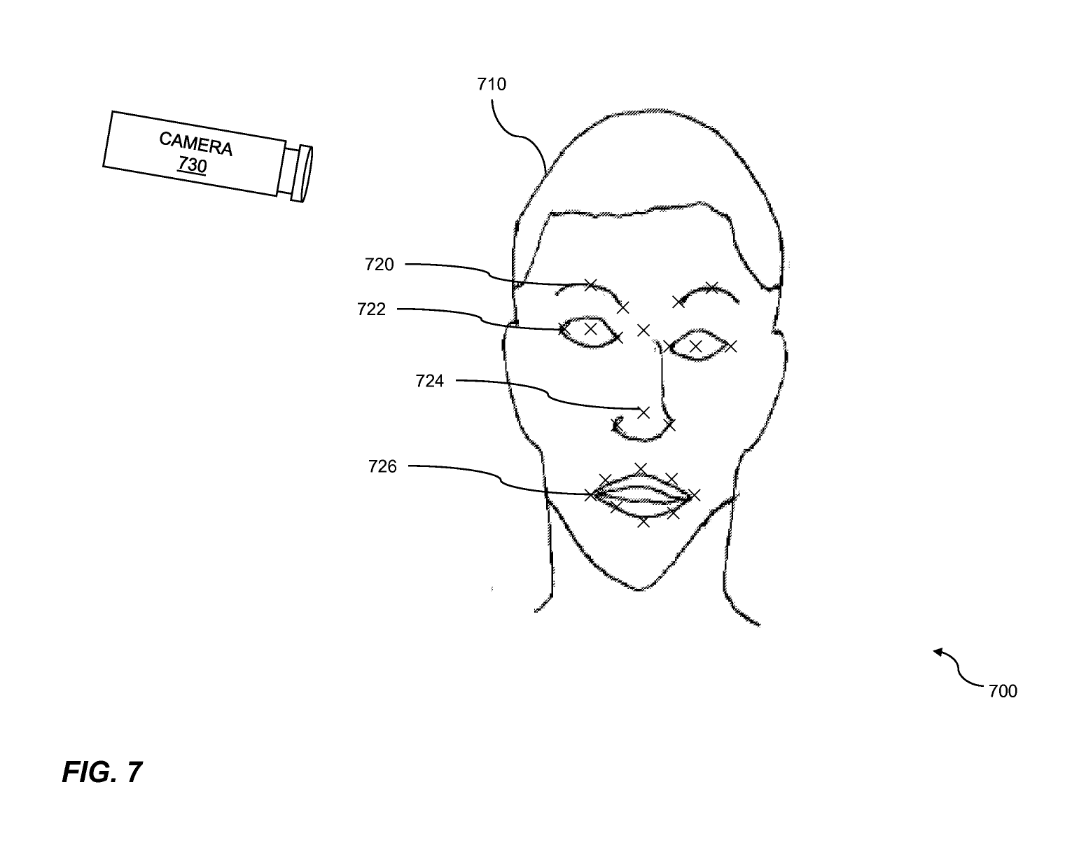

FIG. 7 shows a diagram 700 illustrating example facial data collection including landmarks. A face 710 can be observed using a camera 730 in order to collect facial data that includes facial landmarks. The facial data can be collected from a plurality of people using one or more of a variety of cameras. As discussed above, the camera or cameras can include a webcam, where a webcam can include a video camera, a still camera, a thermal imager, a CCD device, a phone camera, a three-dimensional camera, a depth camera, a light field camera, multiple webcams used to show different views of a person, or any other type of image capture apparatus that can allow captured data to be used in an electronic system. The quality and usefulness of the facial data that is captured can depend, for example, on the position of the camera 730 relative to the face 710, the number of cameras used, the illumination of the face, etc. For example, if the face 710 is poorly lit or over-exposed (e.g. in an area of bright light), the processing of the facial data to identify facial landmarks might be rendered more difficult. In another example, the camera 730 being positioned to the side of the person might prevent capture of the full face. Other artifacts can degrade the capture of facial data. For example, the person's hair, prosthetic devices (e.g. glasses, an eye patch, and eye coverings), jewelry, and clothing can partially or completely occlude or obscure the person's face. Data relating to various facial landmarks can include a variety of facial features. The facial features can comprise an eyebrow 720, an outer eye edge 722, a nose 724, a corner of a mouth 726, and so on. Any number of facial landmarks can be identified from the facial data that is captured. The facial landmarks that are identified can be analyzed to identify facial action units. For example, the action units that can be identified include AU02 outer brow raiser, AU14 dimpler, AU17 chin raiser, and so on. Any number of action units can be identified. The action units can be used alone and/or in combination to infer one or more mental states and emotions. A similar process can be applied to gesture analysis (e.g. hand gestures).

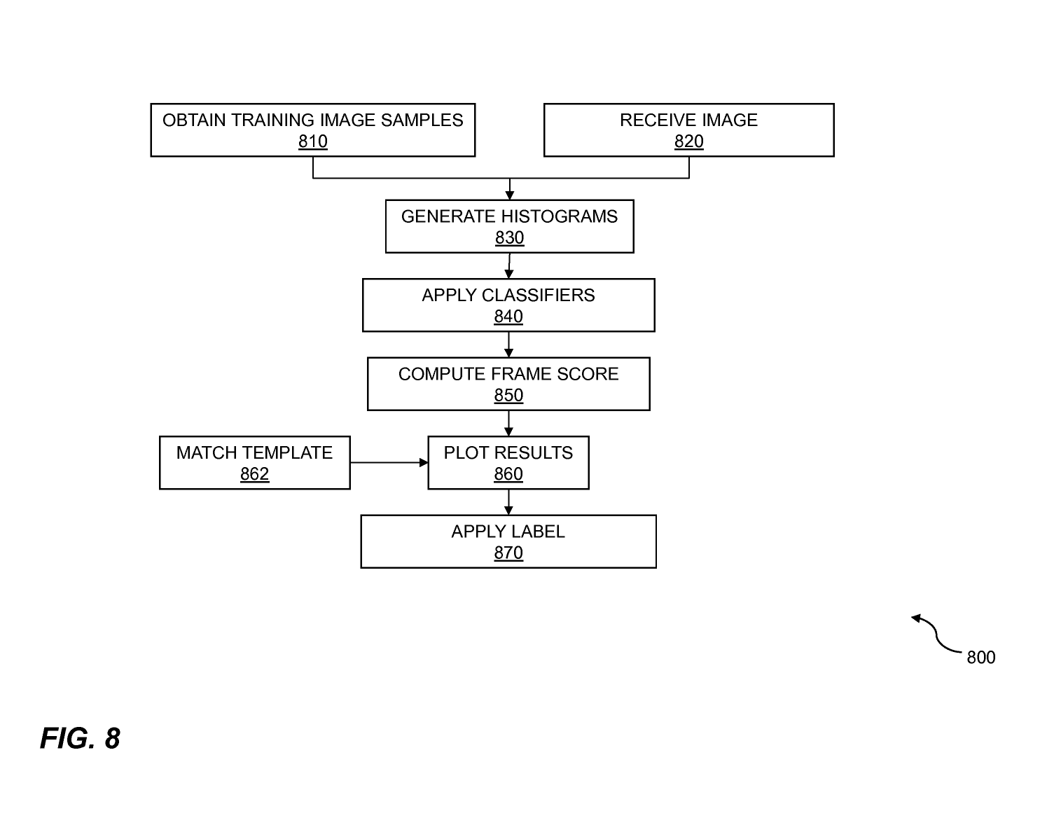

FIG. 8 is a flow for detecting facial expressions. The flow 800 can be used to automatically detect a wide range of facial expressions. A facial expression can produce strong emotional signals that can indicate valence and discrete emotional states. The discrete emotional states can include contempt, doubt, defiance, happiness, fear, anxiety, and so on. The detection of facial expressions can be based on the location of facial landmarks. The detection of facial expressions can be based on determination of action units (AU) where the action units are determined using FACS coding. The AUs can be used singly or in combination to identify facial expressions. Based on the facial landmarks, one or more AUs can be identified by number and intensity. For example, AU12 can be used to code a lip corner puller and can be used to infer a smirk.

The flow 800 begins by obtaining training image samples 810. The image samples can include a plurality of images of one or more people. Human coders who are trained to correctly identify AU codes based on the FACS can code the images. The training or “known good” images can be used as a basis for training a machine learning technique. Once trained, the machine learning technique can be used to identify AUs in other images that can be collected using a camera 730, for example. The flow 800 continues with receiving an image 820. The image 820 can be received from the camera 730. As discussed above, the camera or cameras can include a webcam, where a webcam can include a video camera, a still camera, a thermal imager, a CCD device, a phone camera, a three-dimensional camera, a depth camera, a light field camera, multiple webcams used to show different views of a person, or any other type of image capture apparatus that can allow captured data to be used in an electronic system. The image 820 that is received can be manipulated in order to improve the processing of the image. For example, the image can be cropped, scaled, stretched, rotated, flipped, etc. in order to obtain a resulting image that can be analyzed more efficiently. Multiple versions of the same image can be analyzed. For example, the manipulated image and a flipped or mirrored version of the manipulated image can be analyzed alone and/or in combination to improve analysis. The flow 800 continues with generating histograms 830 for the training images and the one or more versions of the received image. The histograms can be generated for one or more versions of the manipulated received image. The histograms can be based on a HOG or another histogram. As described above, the HOG can include feature descriptors and can be computed for one or more regions of interest in the training images and the one or more received images. The regions of interest in the images can be located using facial landmark points, where the facial landmark points can include outer edges of nostrils, outer edges of the mouth, outer edges of eyes, etc. A HOG for a given region of interest can count occurrences of gradient orientation within a given section of a frame from a video, for example.

The flow 800 continues with applying classifiers 840 to the histograms. The classifiers can be used to estimate probabilities where the probabilities can correlate with an intensity of an AU or an expression. The choice of classifiers used can be based on the training of a supervised learning technique to identify facial expressions, for example. The classifiers can be used to identify into which of a set of categories a given observation can be placed. For example, the classifiers can be used to determine a probability that a given AU or expression is present in a given image or frame of a video. In various embodiments, the one or more AUs that are present include AU01 inner brow raiser, AU12 lip corner puller, AU38 nostril dilator, and so on. In practice, the presence or absence of any number of AUs can be determined. The flow 800 continues with computing a frame score 850. The score computed for an image, where the image can be a frame from a video, can be used to determine the presence of a facial expression in the image or video frame. The score can be based on one or more versions of the image 820 or manipulated image. For example, the score can be based on a comparison of the manipulated image to a flipped or mirrored version of the manipulated image. The score can be used to predict a likelihood that one or more facial expressions are present in the image. The likelihood can be based on computing a difference between the outputs of a classifier used on the manipulated image and on the flipped or mirrored image, for example. The classifier that is used can be used to identify symmetrical facial expressions (e.g. smile), asymmetrical facial expressions (e.g. outer brow raiser), and so on.

The flow 800 continues with plotting results 860. The results that are plotted can include one or more scores for one or frames computed over a given time t. For example, the plotted results can include classifier probability results from analysis of HOGs for a sequence of images and video frames. The plotted results can be matched with a template 862. The template can be temporal and can be represented by a centered box function or another function. A best fit with one or more templates can be found by computing a minimum error. Other best-fit techniques can include polynomial curve fitting, geometric curve fitting, and so on. The flow 800 continues with applying a label 870. The label can be used to indicate that a particular facial expression has been detected in the one or more images or video frames of the image 820. For example, the label can be used to indicate that any of a range of facial expressions has been detected, including a smile, an asymmetric smile, a frown, and so on.

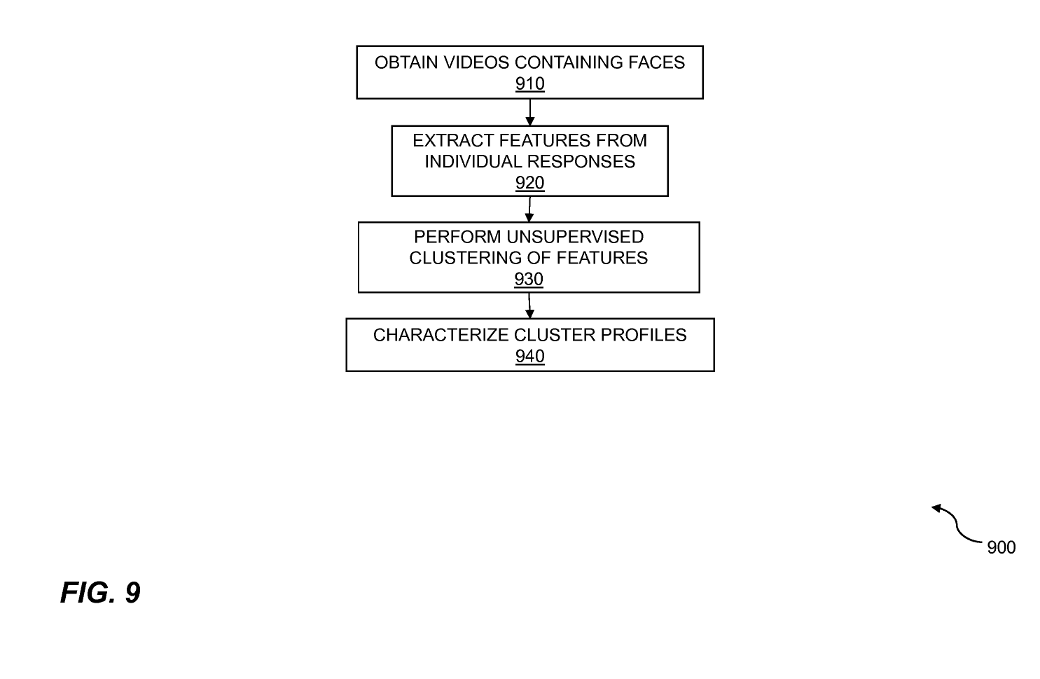

FIG. 9 is a flow 900 for the large-scale clustering of facial events. As discussed above, collection of facial video data from one or more people can include a web-based framework. The web-based framework can be used to collect facial video data from large numbers of people located over a wide geographic area, for example. The web-based framework can include an opt-in feature that allows people to agree to facial data collection. The web-based framework can be used to render and display data to one or more people and can collect data from the one or more people. For example, the facial data collection can be based on showing one or more viewers a video media presentation through a website. The web-based framework can be used to display the video media presentation or event and to collect videos from any number of viewers who are online. That is, the collection of videos can be crowdsourced from those viewers who elected to opt-in to the video data collection. The video event can be a commercial, a political ad, an educational segment, etc. The flow 900 begins with obtaining videos containing faces 910. The videos can be obtained using one or more cameras, where the cameras can include a webcam coupled to one or more devices employed by the one or more people using the web-based framework. The flow 900 continues with extracting features from the individual responses 920. The individual responses can include videos containing faces observed by the one or more webcams. The features that are extracted can include facial features such as an eyebrow, a nostril, an eye edge, a mouth edge, and so on. The feature extraction can be based on facial coding classifiers, where the facial coding classifiers output a probability that a specified facial action has been detected in a given video frame. The flow 900 continues with performing unsupervised clustering of features 930. The unsupervised clustering can be based on an event. The unsupervised clustering can be based on a K-Means, where the K of the K-Means can be computed using a Bayesian Information Criterion (BICk), for example, to determine the smallest value of K that meets system requirements. Any other criterion for K can be used. The K-Means clustering technique can be used to group one or more events into various respective categories. The flow 900 continues with characterizing cluster profiles 940. The profiles can include a variety of facial expressions and can include smiles, asymmetric smiles, eyebrow raisers, eyebrow lowerers, etc. The profiles can be related to a given event. For example, a humorous video can be displayed in the web-based framework and the video data of people who have opted-in can be collected. The characterization of the collected and analyzed video can depend in part on the number of smiles that occurred at various points throughout the humorous video. Similarly, the characterization can be performed on collected and analyzed videos of people viewing a news presentation. The characterized cluster profiles can be further analyzed based on demographic data. For example, the number of smiles resulting from people viewing a humorous video can be compared to various demographic groups, where the groups can be formed based on geographic location, age, ethnicity, gender, and so on.

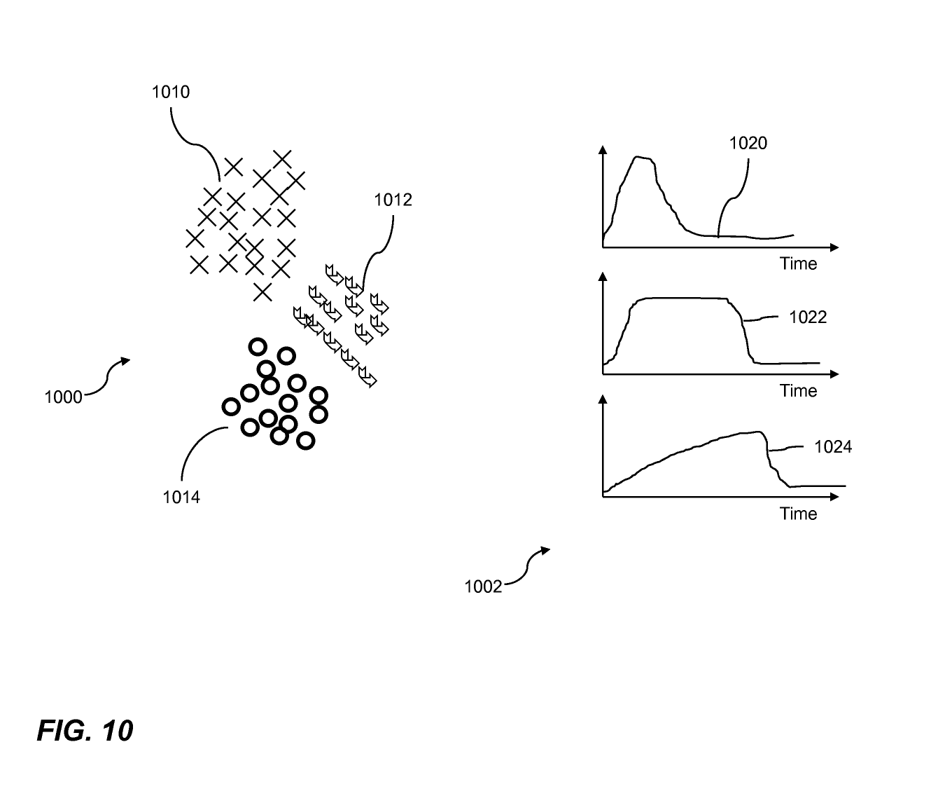

FIG. 10 shows example unsupervised clustering of features and characterization of cluster profiles. Features including samples of facial data can be clustered using unsupervised clustering. Various clusters can be formed, which include similar groupings of facial data observations. The example 1000 shows three clusters 1010, 1012, and 1014. The clusters can be based on video collected from people who have opted-in to video collection. When the data collected is captured using a web-based framework, then the data collection can be performed on a grand scale, including hundreds, thousands, or even more participants who can be located locally and/or across a wide geographic area. Unsupervised clustering is a technique that can be used to process the large amounts of captured facial data and to identify groupings of similar observations. The unsupervised clustering can also be used to characterize the groups of similar observations. The characterizations can include identifying behaviors of the participants. The characterizations can be based on identifying facial expressions and facial action units of the participants. Some behaviors and facial expressions can include faster or slower onsets, faster or slower offsets, longer or shorter durations, etc. The onsets, offsets, and durations can all correlate to time. The data clustering that results from the unsupervised clustering can support data labeling. The labeling can include FACS coding. The clusters can be partially or totally based on a facial expression resulting from participants viewing a video presentation, where the video presentation can be an advertisement, a political message, educational material, a public service announcement, and so on. The clusters can be correlated with demographic information, where the demographic information can include educational level, geographic location, age, gender, income level, and so on.

Cluster profiles 1002 can be generated based on the clusters that can be formed from unsupervised clustering, with time shown on the x-axis and intensity or frequency shown on the y-axis. The cluster profiles can be based on captured facial data including facial expressions, for example. The cluster profile 1020 can be based on the cluster 1010, the cluster profile 1022 can be based on the cluster 1012, and the cluster profile 1024 can be based on the cluster 1014. The cluster profiles 1020, 1022, and 1024 can be based on smiles, smirks, frowns, or any other facial expression. Emotional states of the people can be inferred by analyzing the clustered facial expression data. The cluster profiles can be plotted with respect to time and can show a rate of onset, a duration, and an offset (rate of decay). Other time-related factors can be included in the cluster profiles. The cluster profiles can be correlated with demographic information as described above.

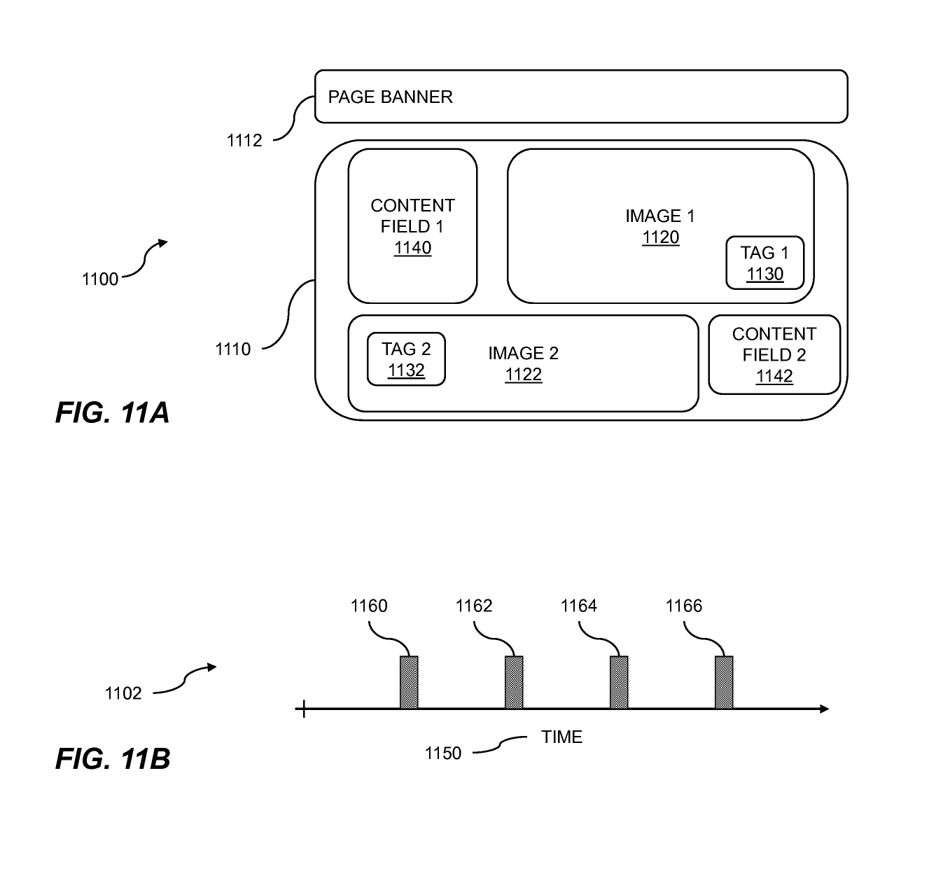

FIG. 11A shows example tags embedded in a webpage. A webpage 1100 can include a page body 1110, a page banner 1112, and so on. The page body can include one or more objects, where the objects can include text, images, videos, audios, and so on. The example page body 1110 includes a first image, image 1 1120, a second image, image 2 1122, a first content field, content field 1 1140, and a second content field, content field 2 1142. In practice, the page body 1110 can contain any number of images and content fields, and can include one or more videos, one or more audios, and so on. The page body can include embedded tags, tag 1 1130 and tag 2 1132. In the example shown, tag 1 1130 is embedded in image 1 1120, and tag 2 1132 is embedded in image 2 1122. In embodiments, any number of tags can be imbedded. Tags can also be imbedded in content fields, in videos, in audios, etc. When a user mouses over a tag, or clicks on an object associated with a tag, the tag can be invoked. For example, when the user mouses over tag 1, then tag 1 can be invoked. Invoking tag 1 can include enabling a camera coupled to a user's device and can include capturing one or more images of the user as the user views a digital experience. In a similar manner, when the user mouses over tag 2, tag 2 can be invoked. Invoking tag 2 can include enabling the camera and capturing images of the user. In other embodiments, other actions can be taken based on invocation of the one or more tags. For example, invoking an embedded tag can initiate an analysis technique, post to social media, award to the user a coupon or other prize, initiate mental state analysis, perform emotion analysis, and so on.

FIG. 11B shows example tag invoking to collect images. As stated above, a digital experience can be a video, a webpage, and so on. A video 1102 can include one or more embedded tags tag 1160, tag 1162, tag 1164, tag 1166, and so on. In practice, any number of tags can be included in the digital experience. The one or more tags can be invoked during the digital experience. The collection of the invoked tags can occur over time as represented by timeline 1150. When a tag is encountered in the digital experience, the tag can be invoked. For example, when tag 1160 is encountered, invoking the tag can enable a camera coupled to a user device and can capture one or more images of the user viewing the digital experience. Invoking a tag can depend on opt-in by the user. For example, if a user has agreed to participate in a study by indicating opt-in, then the camera coupled to the user device can be enabled and one or more images of the user can be captured. If the user has not agreed to participate in the study and has not indicated opt-in, then invoking tag 1160 does not enable the camera nor capture images of the user during the digital experience. The user can indicate opt-in for certain types of participation, where opt-in can be dependent on content in the digital experience. For example, the user could opt-in to participation in a study of political campaign messages and not to opt-in for a particular advertisement study. In that case, tags would be embedded in the digital experience that are related to political campaign messages can enable the camera and image capture when invoked. But tags imbedded in the digital experience that are related to advertisements would not enable the camera when invoked. Various other situations of tag invocation are possible.

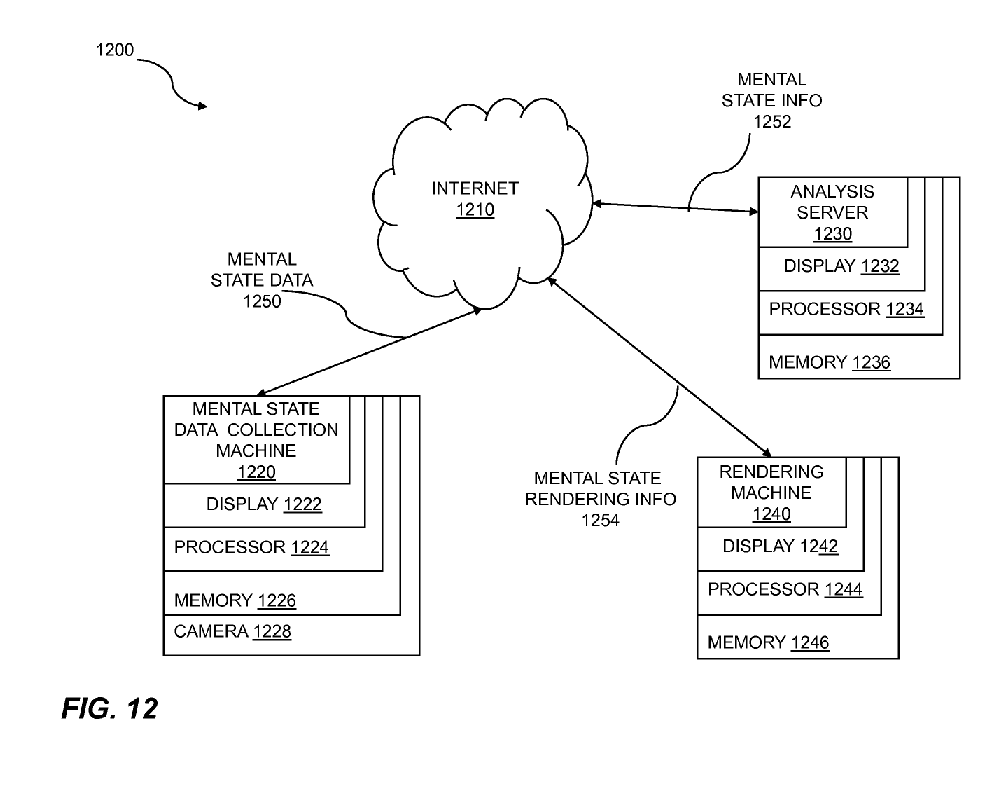

FIG. 12 is a system diagram for mental state analysis for expressions. The diagram illustrates an example system 1200 for mental state collection, analysis, and rendering. The system 1200 can be used for expression analysis. The system 1200 can include one or more client machines or mental state data collection machines or devices 1220 linked to an analysis server 1230 via the Internet 1210 or another computer network. The client machine 1220 can comprise one or more processors 1224 coupled to a memory 1226 which can store and retrieve instructions, a display 1222, and a camera 1228. The memory 1226 can be used for storing instructions, mental state data, mental state information, mental state analysis, expression analysis, and market research information. The display 1222 can be any electronic display, including but not limited to, a computer display, a laptop screen, a net-book screen, a tablet computer screen, a cell phone display, a mobile device display, a remote with a display, a television, a projector, or the like. The camera 1228 can comprise a video camera, still camera, thermal imager, CCD device, phone camera, three-dimensional camera, depth camera, multiple webcams used to show different views of a person, or any other type of image capture apparatus that can allow captured data to be used in an electronic system. The processor(s) 1224 of the mental state data collection machine 1220 can be configured to receive mental state data from people, and in some cases to analyze the mental state data to produce mental state information. The mental state information can be output in real time (or near real time), based on mental state data captured using the camera 1228. In other embodiments, the processor(s) 1224 of the client machine 1220 can be configured to receive mental state data from one or more people, analyze the mental state data 1250 to produce mental state information, and send the mental state information 1252 to the analysis server 1230.

The analysis server 1230 can comprise one or more processors 1234 coupled to a memory 1236 which can store and retrieve instructions, and a display 1232. The analysis server 1230 can receive mental state data and analyze the mental state data to produce mental state information so that the analyzing of the mental state data can be performed by a web service. The analysis server 1230 can use mental state data or mental state information received from the client machine 1220. This received data along with other data and information related to mental states and analysis of the mental state data can be considered mental state analysis information 1252 and can be transmitted to and from the analysis server using the Internet 1210 or another type of network. In some embodiments, the analysis server 1230 receives mental state data and/or mental state information from a plurality of client machines and aggregates the mental state information. The analysis server can evaluate expressions for mental states.

In some embodiments, a displayed rendering of mental state analysis can occur on a different computer than the client machine 1220 or the analysis server 1230. The machine performing the rendering can be termed a rendering machine 1240, and can receive mental state rendering information, mental state analysis information, mental state information, expressions, and graphical display information—collectively referred to as mental state rendering information 1254. In embodiments, the rendering machine 1240 comprises one or more processors 1244 coupled to a memory 1246 which can store and retrieve instructions, and a display 1242. The rendering can be any visual, auditory, or other form of communication directed towards one or more individuals. The rendering can include an email, a text message, a tone, an electrical pulse, or the like. The system 1200 can include a computer program product embodied in a non-transitory computer readable medium comprising: code for determining an expression to be detected on one or more devices; code for watching, by background process on the one or more devices, for the expression; code for identifying an occurrence of the expression; and code for providing notification that the expression was identified.

Each of the above methods may be executed on one or more processors on one or more computer systems. Embodiments may include various forms of distributed computing, client/server computing, and cloud based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are neither limited to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the forgoing examples should not limit the spirit and scope of the present invention; rather it should be understood in the broadest sense allowable by law.

What is claimed is:

1. A computer-implemented method for analysis comprising:
determining an expression to be detected on one or more devices;
monitoring, by background process on the one or more devices, for the expression;
identifying an occurrence of the expression; and
providing notification that the expression was identified.

2. The method of claim 1 further comprising enabling emotion services using the one or more devices.

3. The method of claim 2 wherein the emotion services include detecting smiles, expressions, frowns, heart rate, eyebrow raises, brow furrows, concentration, being expressive, and laughing.

4. The method of claim 2 wherein the emotion services are provided on a device.

5. The method of claim 2 wherein applications use the enabling.

6. The method of claim 1 wherein a foreground application receives the providing of the notification.

7. The method of claim 1 wherein a camera sensor is on continuously as part of the monitoring.

8. The method of claim 1 wherein the providing includes delivering a coupon or a reward.

9. The method of claim 8 wherein the providing is part of a gaming experience.

10. The method of claim 1 wherein the expression is a reflection of a mental state.

11. The method of claim 1 wherein the identifying is provided with a confidence interval.

12. The method of claim 1 wherein the monitoring is a background operation within the one or more devices.

13. The method of claim 1 wherein the monitoring is accomplished passively.

14. The method of claim 1 wherein the determining is accomplished by describing a mental state.

15. The method of claim 1 wherein the determining is accomplished by inputting an expression description.

16. The method of claim 1 wherein the determining is accomplished by providing an expression.

17. The method of claim 1 wherein the providing an expression is via an image.

18. The method of claim 1 wherein a foreground application receives the providing of the notification, and wherein the providing an expression is via an image, and further comprising:
enabling emotion services using the one or more devices; and
performing an emotion response action in response to the provided notification.

19. The method of claim 18 wherein the foreground application comprises a messaging application configured to send messages between a sender and a recipient, and wherein, upon the recipient accessing a first message, the background process identifies an occurrence of the identified expression, and wherein the emotion response action includes sending a second message to the sender which includes emotion scoring, wherein the second message is indicative of an emotional response of the recipient in response to the first message.

20. The method of claim 19 wherein the second message further includes the image.

21. The method of claim 19 wherein the second message further includes an emoji.

22. The method of claim 18 wherein the foreground application comprises a social media application configured to display a first message, and wherein, upon a recipient accessing the first message, the background process identifies an occurrence of the identified expression, and wherein the emotion response action includes posting a second message on a social media system which includes emotion scoring, wherein the second message is indicative of an emotional response of the recipient in response to the first message.

23. The method of claim 18 wherein the foreground application comprises a social media application configured to display a message, and wherein, upon a recipient accessing the message, the background process identifies an occurrence of the identified expression, and wherein the emotion response action includes generating an automatic like of the message.

24. The method of claim 18 wherein the emotion response action includes invoking an automated help application.

25. A computer program product embodied in a non-transitory computer readable medium for mental state analysis, the computer program product comprising:
code for determining an expression to be detected on one or more devices;
code for monitoring, by background process on the one or more devices, for the expression;
code for identifying an occurrence of the expression; and
code for providing notification that the expression was identified.

26. A computer system for mental state analysis comprising:
a memory which stores instructions;
one or more processors attached to the memory wherein the one or more processors, when executing the instructions which are stored, are configured to:
determine an expression to be detected on one or more devices;
monitor, by background process on the one or more devices, for the expression;
identify an occurrence of the expression; and
provide notification that the expression was identified.
